(19) United States
(12) Patent Application Publication
(10) Pub. No.: US 2016/0067868 A1
(43) Pub. Date: Mar. 10, 2016

(54) MODULAR END EFFECTOR

(71) Applicant: The Boeing Company, Huntington Beach, CA (US)

(72) Inventors: John Richard Porter, Edgewood, WA (US); Kevin Michael Bell, Maple Valley, WA (US)

(21) Appl. No.: 14/478,299

(22) Filed: Sep. 5, 2014

(51) Int. Cl. B25J 17/02

(52) U.S. Cl. CPC B25J 17/0208

(57) ABSTRACT

A system and method is disclosed of configuring a robotic end effector to prevent two or more axes of joints of a robotic arm from being in alignment. A connecting part is attached between a robotic arm and a tool in a pre-determined configuration chosen to prevent the two or more axes of joints of the robotic arm from being in alignment for a selected process involving the tool. Reconfigurable end plates may be disposed between the connecting part and the robotic arm, and between the connecting part and the tool to put the connecting part into the pre-determined configuration which prevents the two or more axes of the joints of the robotic arm from being in alignment for the selected process involving the tool.

### FIELD OF THE DISCLOSURE

This disclosure relates to a system and method of configuring a robotic end effector to prevent two or more axes of joints of a robotic arm from being in alignment.

### BACKGROUND

Robotic systems having robotic arms are used to move robotic end effectors attached to the robotic arms in order to perform a selected process on a part using a tool comprising part of the robotic end effector. Robotic arms of robotic systems have multiple joints at which the robotic arms bend to achieve motion in X, Y, and Z directions.

Each joint of the robotic arms have an axis about which the joint moves. When two or more axes of the joints are in alignment (referred to as singularity) the robotic system has endless movement solutions which causes extremely slow movement due to the processor of the robotic system having to work through the endless movement solutions to determine how to move the joints. Singularity is undesired as it creates time delays and adds cost in using the robotic system. Additionally, programming errors may occur due to singularity.

A robotic system and method of use are needed to reduce or eliminate one or more issues of one or more of the existing robotic systems and methods.

### SUMMARY

In one embodiment, a method is disclosed of configuring a robotic end effector to prevent two or more axes of joints of a robotic arm from being in alignment. A connecting part is attached between a robotic arm and a tool in a pre-determined configuration chosen to prevent two or more axes of joints of the robotic arm from being in alignment for a selected process involving the tool.

In another embodiment, a kit is disclosed for configuring a robotic end effector to prevent two or more axes of joints of a robotic arm from being in alignment. The kit includes a connecting part configured to be attached between a robotic arm and a tool in a pre-determined configuration chosen to prevent two or more axes of joints of the robotic arm from being in alignment for a selected process involving the tool. The kit further includes one or more reconfigurable end plates.

In still another embodiment, a robotic system is disclosed for configuring a robotic end effector to prevent two or more axes of joints of a robotic arm from being in alignment. The robotic system includes a robot and a robotic end effector. The robot includes a robotic arm having multiple joints. The robotic end effector includes a tool, and a connecting part attached between the robotic arm and the tool in a pre-determined configuration chosen to prevent two or more axes of the joints from being in alignment for a selected process involving the tool.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of one embodiment of a robotic system;

FIG. 2 illustrates a perspective view of the robotic end effector of FIG. 1 detached from the robotic arm;

FIG. 3 illustrates a block diagram of one embodiment of a robotic system for preventing two or more axes of joints of a robotic arm from being in alignment;

FIG. 4 is a flowchart illustrating one embodiment of a method of configuring a robotic end effector to prevent two or more axes of joints of a robotic arm from being in alignment;

FIG. 5 is a flow diagram of aircraft production and service methodology; and

FIG. 6 is a block diagram of an aircraft.

### DETAILED DESCRIPTION

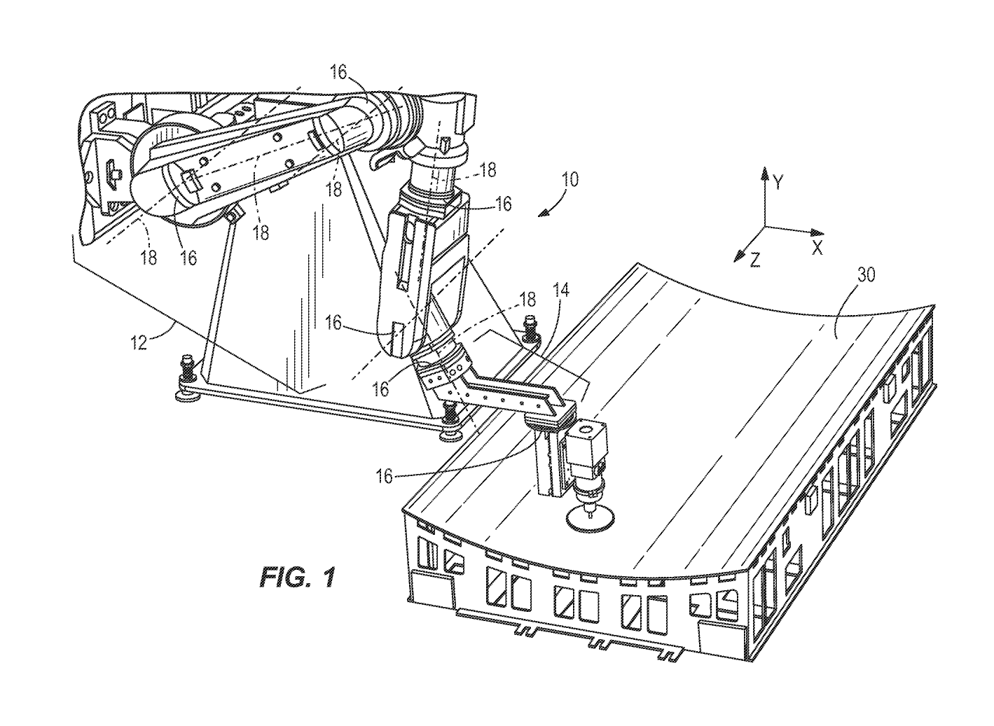

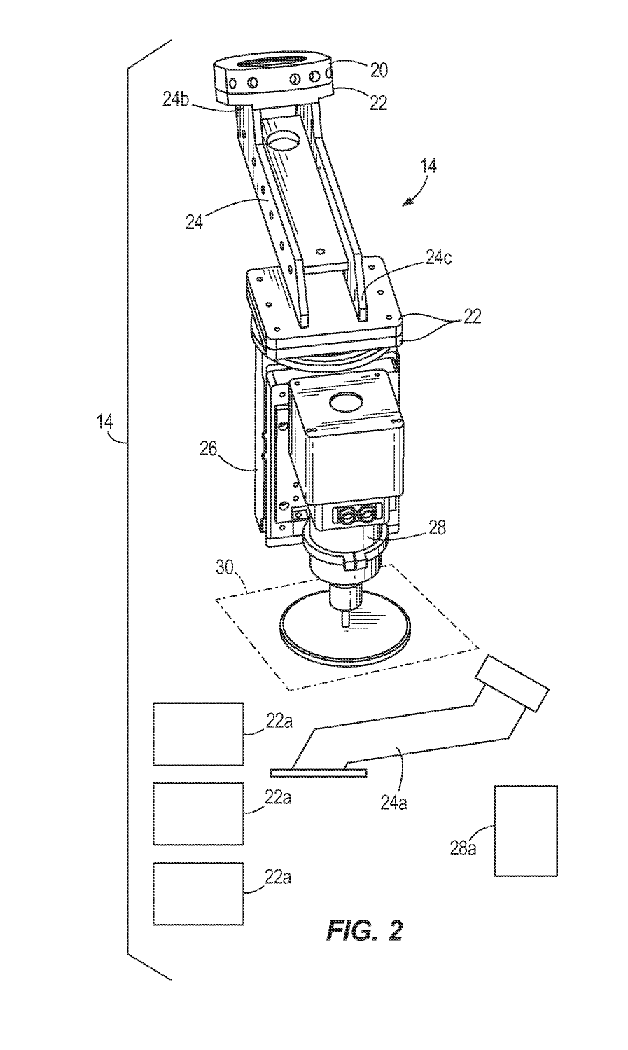

FIG. 1 illustrates a perspective view of one embodiment of a robotic system 10. The robotic system 10 includes a robotic arm 12 and a robotic end effector 14 attached to the robotic arm 12. FIG. 2 illustrates a perspective view of the robotic end effector 14 of FIG. 1 detached from the robotic arm. As shown in FIG. 1, the robotic arm 12 comprises multiple joints 16 at which the robotic arm 12 bends to achieve motion in X, Y, and Z directions. Each joint 16 has an axis 18 about which the joint 16 moves. When two or more axes 18 of the joints 16 are in alignment (referred to as singularity) the robotic system 10 may trigger endless movement solutions which causes extremely slow movement due to the processor (not shown) of the robotic system 10 having to work through the endless movement solutions to determine how to move the joints 16. In one embodiment, the term being in alignment comprises two or more of the joints 16 being within a range of +10 to −10 degrees. In other embodiments, the term being in alignment may comprise two or more of the joints 16 being within a further varied range. Singularity is undesired as it creates adverse operation effects in using the robotic system 10.

The robotic system 10 is used to configure the robotic end effector 14 to prevent two or more axes 18 of the joints 16 of the robotic arm 12 from being in alignment thereby avoiding the time delays and the added manufacturing cost of singularity. As shown in FIG. 2, the robotic end effector 14 includes a quick-change connector 20, reconfigurable end plates 22, a connecting part 24, a tool-holding part 26, and a tool 28.

The robotic system 10 may further include a second connecting part 24a which may be substituted for the connecting part 24 (having a different size, shape, or orientation), a second tool 28a (for a different function) which may be substituted for the tool 28, and additional reconfigurable end plates 22a (having a different size, shape, or orientation) which may be substituted for the reconfigurable end plates 22. In other embodiments, the robotic system 10 may include any number of varying connecting parts which may be substituted for the connecting part 24, any number of additional tools which may be substituted for the tool 28, and any number of additional reconfigurable end plates 22a which may be substituted for the reconfigurable end plates 22. In one embodiment, a kit for configuring the robotic end effector 14 to prevent two or more axes of joints 16 of a robotic arm 12 from being in alignment may include the quick-change connector 20, connecting part 24, one or more of the reconfigurable end plates 22, the second connecting part 24a, and the one or more additional reconfigurable end plates 22a. In other embodiments, the kit may include a varying number or combination of the components, one or more of the components may not be present, or additional components may be added.

The quick-change connector 20 is attached between the robotic arm 12 and one of the reconfigurable end plates 22. In other embodiments, any number (including zero) of the reconfigurable end plates 22 may be used at this location. The reconfigurable end plate 22 at this location is attached between the quick-change connector 20 and a first end 24b of the connecting part 24. Two reconfigurable end plates 22 are attached between a second opposed end 24c of the connecting part 24 and the tool-holding part 26. In other embodiments, any number of the reconfigurable end plates 22 (including zero) may be used at this location. The tool-holding part 26 is attached to the tool 28. In other embodiments, the robotic end effector 14 may include additional components, one or more of the components may not be present, or one or more of the components may be varied in number, size, shape, orientation, or configuration.

The connecting part 24 and the reconfigurable end plates 22 are attached between the robotic arm 12 and the tool 28 in a pre-determined configuration chosen to prevent two or more axes 18 of the joints 16 from being in alignment for a selected process involving the tool 28 performed on a part 30. The connecting part 24 and the reconfigurable end plates 22 collectively are chosen to have a size, shape, orientation, and/or configuration which prevent two or more axes 18 of the joints 16 of the robotic arm 12 from being in alignment for the selected process involving the tool 28 on the part 30.

When the second tool 28a is substituted for the tool 28 to perform a second selected process on the part 30 or on another part, the varied size, shape, orientation, and/or configuration second connecting part 24a may be substituted for the connecting part 24 in order to prevent two or more axes 18 of the joints 16 of the robotic arm 12 from being in alignment for the second selected process on the part 30 or on another part.

Similarly, the reconfigurable end plates 22, 22a may be reconfigured relative to the connecting part 24 or to the second connecting part 24a (if it is substituted for the connecting part 24) in order to prevent two or more axes 18 of the joints 16 of the robotic arm 12 from being in alignment for the second selected process on the part 30 or on another part. By varying the size, shape, orientation, and/or configuration of the connecting part 24, 24a, and/or the reconfigurable end plates 22, 22a the robotic end effector 14 may be configured to prevent two or more axes of joints 16 of the robotic arm 12 from being in alignment for any type of process performed by the tool 28, 28a on any type of part 30.

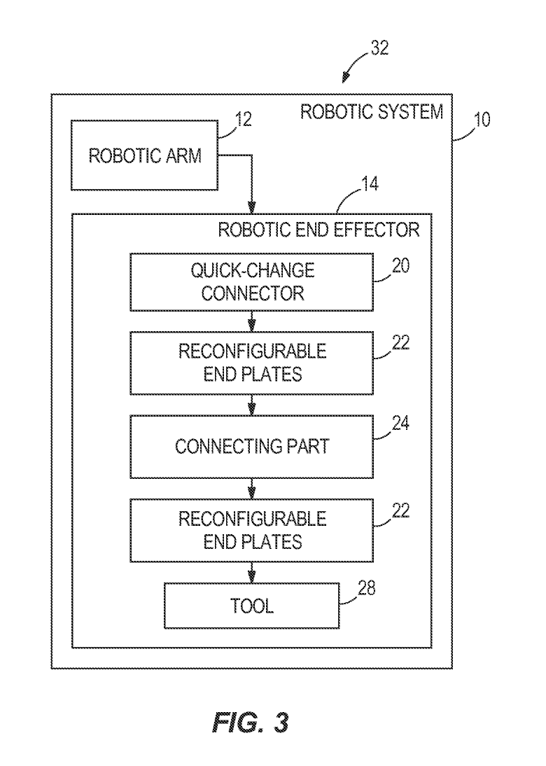

FIG. 3 illustrates a block diagram of one embodiment of a robotic system 10 for preventing two or more axes of joints of a robotic arm 12 from being in alignment. The robotic system 10 includes the robotic arm 12 attached to a robotic end effector 14. The robotic end effector 14 includes a quick-change connector 20 attached to reconfigurable end plates 22. The robotic end effector 14 further includes a connecting part 24 attached between reconfigurable end plates 22. The connecting part 24 is attached to the tool 28 with one or more of the attached reconfigurable end plates 22 disposed between the connecting part 24 and the tool 28. In other embodiments, the robotic end effector 14 may include additional components, one or more of the components may not be present, or the components may be varied in their connection.

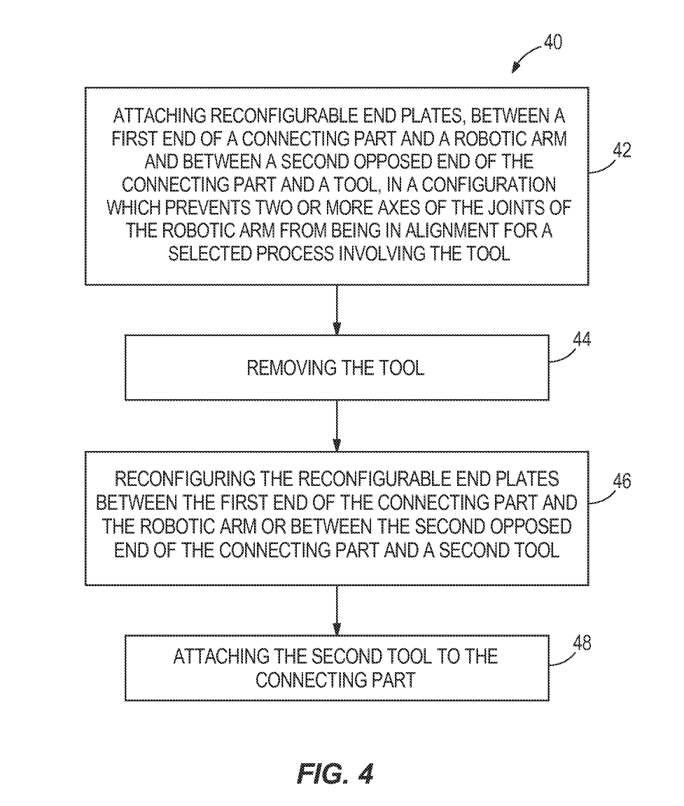

FIG. 4 is a flowchart illustrating one embodiment of a method 40 of configuring a robotic end effector (14) to prevent two or more axes (18) of joints (16) of a robotic arm (12) from being in alignment (please note that the reference numbers contained in parentheses are shown collectively in FIGS. 1-3). The method 40 may utilize the robotic system (10) of FIGS. 1, 2, and 3. In other embodiments, the method 40 may utilize varying robotic systems. In step 42, reconfigurable end plates (22) are attached, between a first end (24b) of a connecting part (24) and the robotic arm (12) and between a second opposed end (24c) of the connecting part (24) and the tool (28), in a configuration which prevents two or more axes (18) of the joints (16) of the robotic arm (12) from being in alignment for a selected process involving the tool (28). In another embodiment, any number (including zero) of reconfigurable end plates (22) may be attached between the first end (24b) of the connecting part (24) and the robotic arm (12) or between the second opposed end (24c) of the connecting part (24) and the tool (28). In still another embodiment, the connecting part (24) may be attached between the robotic arm (12) and the tool (28), without using any reconfigurable end plates (22), in a configuration in which the size, shape, or orientation of the connecting part (24) is chosen to prevent two or more axes (18) of the joints (16) of the robotic arm (12) from being in alignment for the selected process involving the tool (28). In an additional embodiment, a quick-change connector (20) may be attached between the reconfigurable end plates (22) and the robotic arm (12).

In step 44, the tool (28) is removed. In step 46, the reconfigurable end plates (22) are reconfigured between the first end (24b) of the connecting part (24) and the robotic arm (12) or between the second opposed end (24c) of the connecting part (24) and a second tool (28a). In step 48, the second tool (28a) is attached to the connecting part (24). The reconfiguration of the one or more reconfigurable end plates (22) prevents two or more axes (18) of the joints (16) of the robotic arm (12) from being in alignment for a second selected process involving the second tool (28a).

In another embodiment, the tool (28) and the connecting part (24) may be removed from the robotic arm (12), and a differently sized, differently shaped, or differently oriented second connecting part (24a) may be attached between the robotic arm (12) and a second tool (28a), with the configuration of the second connecting part (24a) chosen to prevent two or more axes (18) of the joints (16) of the robotic arm (12) from being in alignment for a second selected process involving the second tool (28a). In still another embodiment, the tool (28) and the connecting part (24) may be removed from the robotic arm (12), and the reconfigurable end plates (22) may be reconfigured between a first end of a second connecting part (24a) and the robotic arm (12) or between a second opposed end of the second connecting part (24a) and a second tool (28a) in attaching the second connecting part (24a) to the second tool (28a), wherein the configuration of the second connecting part (24a) and the reconfiguration of the reconfigurable end plates (22) prevents two or more axes (18) of the joints (16) of the robotic arm (12) from being in alignment for a second selected process involving the second tool (28a). In other embodiments, one or more of the steps of the method 40 may not be followed or altered in substance or in order, one or more additional steps may be followed, or other changes may be made.

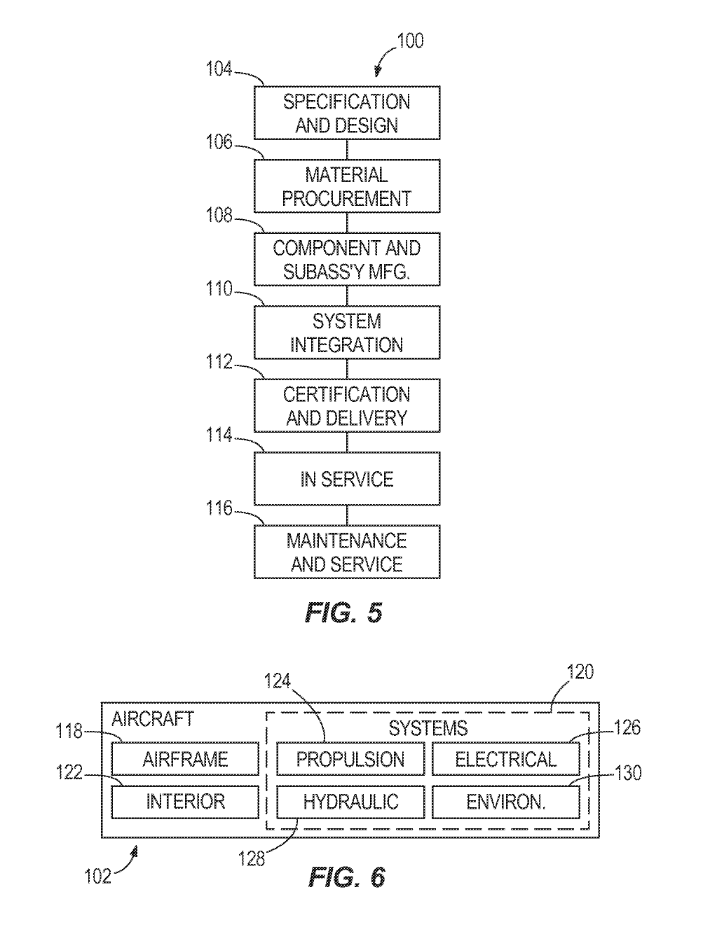

Referring more particularly to the drawings, embodiments of the disclosure may be described in the context of an aircraft manufacturing and service method 100 as shown in FIG. 5 and an aircraft 102 as shown in FIG. 6. The disclosure may be used in subassembly manufacturing 108, system integration 110 and maintenance and service 116, and airframe 118 and interior 122. During pre-production, exemplary method 100 may include specification and design 104 of the aircraft 102 and material procurement 106. During production, component and subassembly manufacturing 108 and system integration 110 of the aircraft 102 takes place. Thereafter, the aircraft 102 may go through certification and delivery 112 in order to be placed in service 114. While in service by a customer, the aircraft 102 is scheduled for routine maintenance and service 116 (which may also include modification, reconfiguration, refurbishment, and so on).

Each of the processes of method 100 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 6, the aircraft 102 produced by exemplary method 100 may include an airframe 118 with a plurality of systems 120 and an interior 122. Examples of high-level systems 120 include one or more of a propulsion system 124, an electrical system 126, a hydraulic system 128, and an environmental system 130. Any number of other systems may be included. Although an aerospace example is shown, the principles of the invention may be applied to other industries, such as the automotive industry.

Apparatus and methods embodied herein may be employed during any one or more of the stages of the production and service method 100. For example, components or subassemblies corresponding to production process 108 may be fabricated or manufactured in a manner similar to components or subassemblies produced while the aircraft 102 is in service. Also, one or more apparatus embodiments, method embodiments, or a combination thereof may be utilized during the production stages 108 and 110, for example, by substantially expediting assembly of or reducing the cost of an aircraft 102. Similarly, one or more of apparatus embodiments, method embodiments, or a combination thereof may be utilized while the aircraft 102 is in service, for example and without limitation, to maintenance and service 116.

The embodiments of the disclosure prevent two or more axes of joints of a robotic arm from being in alignment thereby avoiding additional adverse operational effects.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A method of configuring a robotic end effector to prevent two or more axes of joints of a robotic arm from being in alignment comprising:
attaching a connecting part between a robotic arm and a tool in a pre-determined configuration chosen to prevent two or more axes of joints of the robotic arm from being in alignment for a selected process involving the tool.

2. The method of claim 1 further comprising attaching one or more reconfigurable end plates, between a first end of the connecting part and the robotic arm or between a second opposed end of the connecting part and the tool, in a configuration which prevents the two or more axes of the joints of the robotic arm from being in alignment for the selected process involving the tool.

3. The method of claim 1 further comprising attaching reconfigurable end plates and a quick-change connector between a first end of the connecting part and the robotic arm, and attaching further reconfigurable end plates between a second opposed end of the connecting part and the tool, in a configuration which prevents the two or more axes of the joints of the robotic arm from being in alignment for the selected process involving the tool.

4. The method of claim 1 further comprising selecting the connecting part to have a size, shape, or orientation which prevents the two or more axes of the joints of the robotic arm from being in alignment for the selected process involving the tool.

5. The method of claim 1 wherein the being in alignment is defined as the two or more axes of the joints of the robotic arm being within a range of +10 to −10 degrees.

6. The method of claim 2 further comprising removing the tool, reconfiguring the one or more reconfigurable end plates between the first end of the connecting part and the robotic arm or between the second opposed end of the connecting part and a second tool, and attaching the second tool to the connecting part, wherein the reconfiguration of the one or more reconfigurable end plates prevents the two or more axes of the joints of the robotic arm from being in alignment for a second selected process involving the second tool.

7. The method of claim 4 further comprising removing the tool and the connecting part from the robotic arm, and attaching a differently sized, differently shaped, or differently oriented second connecting part between the robotic arm and a second tool, with the configuration of the second connecting part chosen to prevent the two or more axes of the joints of the robotic arm from being in alignment for a second selected process involving the second tool.

8. The method of claim 7 further comprising attaching reconfigurable end plates, between a first end of the connecting part and the robotic arm and between a second opposed end of the connecting part and the tool, in a configuration which prevents the two or more axes of the joints of the robotic arm from being in alignment for the selected process involving the tool, and after removing the tool and the connecting part from the robotic arm reconfiguring the one or more reconfigurable end plates between a first end of the second connecting part and the robotic arm or between a second opposed end of the second connecting part and the second tool, wherein the reconfiguration of the one or more reconfigurable end plates prevents the two or more axes of the joints of the robotic arm from being in alignment for a second selected process involving the second tool.

9. A kit for configuring a robotic end effector to prevent two or more axes of joints of a robotic arm from being in alignment comprising:
a connecting part configured to be attached between a robotic arm and a tool in a pre-determined configuration chosen to prevent two or more axes of joints of the robotic arm from being in alignment for a selected process involving the tool; and
one or more reconfigurable end plates.

10. The kit of claim 9 wherein the one or more reconfigurable end plates are configured to be attached between a first end of the connecting part and the robotic arm in a configuration which prevents the two or more axes of the joints of the robotic arm from being in alignment for the selected process involving the tool.

11. The kit of claim 9 wherein the one or more reconfigurable end plates are configured to be attached between a second opposed end of the connecting part and the tool in a configuration which prevents the two or more axes of the joints of the robotic arm from being in alignment for the selected process involving the tool.

12. The kit of claim 9 further comprising a quick-change connector which is configured to be attached between the one or more reconfigurable end plates and the robotic arm.

13. The kit of claim 9 wherein the connecting part has a size, shape, or orientation which prevents the two or more axes of the joints of the robotic arm from being in alignment for the selected process involving the tool.

14. The kit of claim 9 wherein the being in alignment is defined as the two or more axes of the joints of the robotic arm being within a range of +10 to −10 degrees.

15. The kit of claim 9 further comprising a second connecting part configured to be attached between the robotic arm and a second tool in a pre-determined configuration chosen to prevent the two or more axes of joints of the robotic arm from being in alignment for a second selected process involving the second tool.

16. A robotic system for configuring a robotic end effector to prevent two or more axes of joints of a robotic arm from being in alignment comprising:
a robot comprising a robotic arm having joints; and
a robotic end effector comprising:
a tool; and
a connecting part attached between the robotic arm and the tool in a pre-determined configuration chosen to prevent two or more axes of the joints from being in alignment for a selected process involving the tool.

17. The robotic system of claim 16 wherein the robotic end effector further comprises one or more reconfigurable end plates, attached between a first end of the connecting part and the robotic arm or attached between a second opposed end of the connecting part and the tool, in a configuration which prevents the two or more axes of the joints of the robotic arm from being in alignment for the selected process involving the tool.

18. The robotic system of claim 16 wherein the robotic end effector further comprises reconfigurable end plates, attached between a first end of the connecting part and the robotic arm and attached between a second opposed end of the connecting part and the tool, in a configuration which prevents the two or more axes of the joints of the robotic arm from being in alignment for the selected process involving the tool.

19. The robotic system of claim 18 wherein the robotic end effector further comprises a quick-change connector attached between the reconfigurable end plates, attached at the first end of the connecting part, and the robotic arm, and a tool-holding part attached between the reconfigurable end plates, attached at the second opposed end of the connecting part, and the tool.

20. The robotic system of claim 16 wherein the connecting part has a size, shape, or orientation which prevents the two or more axes of the joints of the robotic arm from being in alignment for the selected process involving the tool.

21. The robotic system of claim 16 wherein the being in alignment is defined as the two or more axes of the joints of the robotic arm being within a range of +10 to −10 degrees.
